(19) United States
(12) Patent Application Publication
(10) Pub. No.: US 2024/0027403 A1
(43) Pub. Date: Jan. 25, 2024

(54) Guided Wave Non-Destructive Testing Using Magnetostrictive Sensor with Moving Magnet and Partial Activation of Magnetostrictive Strip

(71) Applicants: Sergey Vinogradov, San Antonio, TX (US); Xin Chen, San Antonio, TX (US); Jay Fisher, Alamo Heights, TX (US)

(72) Inventors: Sergey Vinogradov, San Antonio, TX (US); Xin Chen, San Antonio, TX (US); Jay Fisher, Alamo Heights, TX (US)

(21) Appl. No.: 18/357,142

(22) Filed: Jul. 23, 2023

Related U.S. Application Data
(60) Provisional application No. 63/391,718, filed on Jul. 23, 2022.

(51) Int. Cl. G01N 29/24; G01N 29/265

(52) U.S. Cl. CPC G01N 29/2412; G01N 29/265; G01N 2291/044; G01N 2291/0422

(57) ABSTRACT

A “partial activation” method of magnetostrictive guided wave testing of a structure. A coil-wrapped magnetostrictive strip is acoustically coupled to the surface of the structure. A permanent magnet is placed over a portion of the strip, such that the permanent magnet covers all or most of the width of the strip but only a portion of its length. A pulsed alternating current source activates the magnetostrictive strip, thereby producing magnetostrictive vibrations in the magnetostrictive strip, and thereby resulting in guided waves in the structure. Response signals are received, then the permanent magnet is moved to a next position along the length of the magnetostrictive strip. As the magnet is moved along the strip, the strip is activated and response signals are received, thereby testing a desired portion of the structure under the strip. The response signals are analyzed to determine the presence of anomalies in the structure.

### CROSS-REFERENCE TO RELATED APPLICATIONS

This patent application has the benefit of U.S. Provisional Patent App. No. 63/391,718, filed Jul. 23, 2022, entitled “Guided Wave Non-Destructive Testing Using Flexible Magnetostrictive Transducers with Partial Activation by Permanent Magnet(s).

### BACKGROUND OF THE INVENTION

Ultrasonic guided waves are a useful tool for non-destructive defect detection in structures of various materials and geometries. The ultrasonic waves travel long distances and therefore allow inspection of large areas from a single probe location.

Often it is advantageous to inspect the structure from multiple probe locations in a direction normal to the wave beam direction, by using a relatively narrow probe that is moved in a scan path normal to the beam direction, or by using a probe that consists of multiple transducers arranged in a line normal to the beam direction. These approaches, along with ultrasonic beam-forming algorithms that combine the data from the different probe positions, allow determination of defect width and position normal to the beam in addition to distance from the probe. This probe arrangement is in contrast to the use of a single large probe, for example one that encircles an entire pipe circumference, for which only the distance from the probe can be detected.

One established approach to excite such waves in structures is to use electromagnetic acoustic transducers (EMATs), which generate waves in a structure directly via the Lorentz force or by magnetostriction. These transducers typically have a small aperture relative to the desired coverage width; covering a large structure requires moving the transducer along the scan path either manually or by a motorized mechanism. One limitation with this approach is the need to move a cable attached to the transducer. Moving cables are subject to periodic failure. Additionally, cables may bind on geometric features. Another limitation is that an EMAT can generate waves only in highly conducting material; for example, they cannot generally be used on stainless steel structures.

Another approach is a magnetostrictive approach that uses a magnetized ferromagnetic strip wound with an alternating current (AC) excited coil and coupled mechanically or adhesively to the structure under test. The strip and coil form a probe that can be moved along or around the structure, or a multiplicity of such probes can be used. In the case of a moving probe, a cable feeding the AC coil is attached to the probe, and the probe is coupled to the structure at each new test position.

### BRIEF DESCRIPTION OF DRAWINGS

A more complete understanding of the present embodiments and advantages thereof may be acquired by referring to the following description taken in conjunction with the accompanying drawings, in which like reference numbers indicate like features, and wherein:

FIG. 1 illustrates the principle of operation of a magnetostrictive sensor that uses a reversed Wiedemann effect to generate shear horizontal guided waves.

FIG. 2 is a perspective view of a magnetostrictive sensor in accordance with the invention.

FIG. 2A illustrates the sensor configured for compressional guided wave generation.

FIG. 2B illustrates a sensor configured for directional guided waves.

FIG. 3 is a side view of a magnetostrictive sensor in accordance with the invention.

FIGS. 4 and 5 illustrate the sensor operating in a pulse-echo configuration to test a pipeline.

FIG. 6 is a B-scan image of guided wave responses using 250 kHz, five-cycle excitation, by which both the SH0 and SH1 modes will be generated.

FIG. 7 is a synthetic aperture focusing technique (SAFT) image of guided wave responses using the 250 kHz five-cycle excitation.

### DETAILED DESCRIPTION OF THE INVENTION

The following description is directed to a magnetostrictive sensor comprising a magnetostrictive strip coupled to the structure under test, and having a movable magnet that activates only a portion of the strip under which the magnet is positioned. The sensor provides a way to activate only a portion of the strip at a time and is moved along the strip to provide multiple inspection positions. This approach can be used to inspect many different materials. No cables are attached to the moving magnet, avoiding issues related to moving cables.

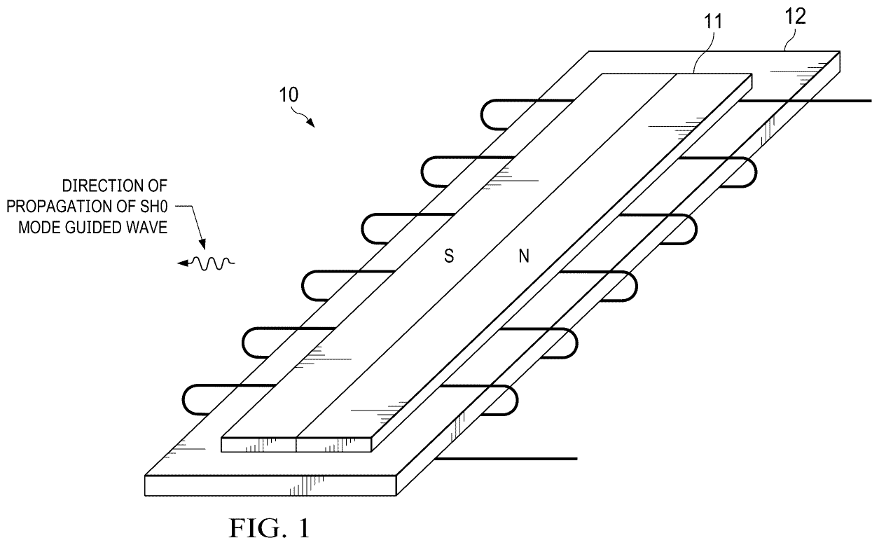

FIG. 1 illustrates the principle of operation of using a conventional magnetostrictive sensor 10. In this configuration, sensor 10 uses the reversed Wiedemann effect to generate shear horizontal (SH) guided waves for testing for defects in a structure. It is placed on the surface of the structure and acoustically coupled to the structure.

Sensor 10 generates SH guided waves by having a static magnetic field applied parallel to the wave propagation direction and perpendicular to a time varying magnetic field. The static magnetic field is generated by a permanent magnet 11. A magnetostrictive strip 12, which comprises a strip of magnetostrictive material wound with a coil, provides the time varying magnetic field. A transmitted wave is generated and if a defect exists, the defect reflects a response signal back to coil-wrapped strip 12.

In the conventional sensor implementation of FIG. 1, magnet 11 has a length covering the full length of strip 12. To test along the length of a pipeline (or other structure), sensor 10 is incrementally moved to different locations. As indicated in the Background, this can result in inefficiency and position errors and longer scan times.

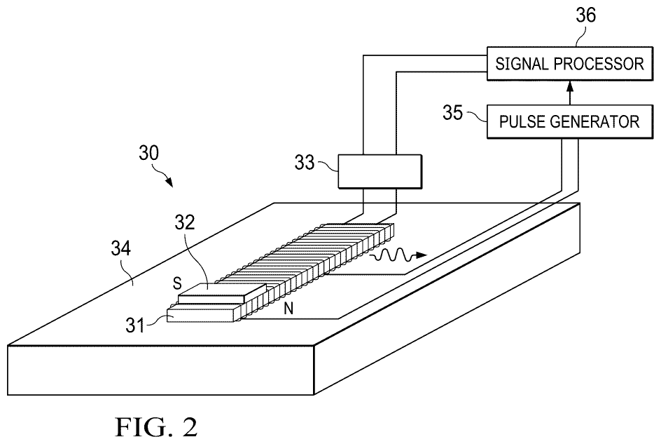

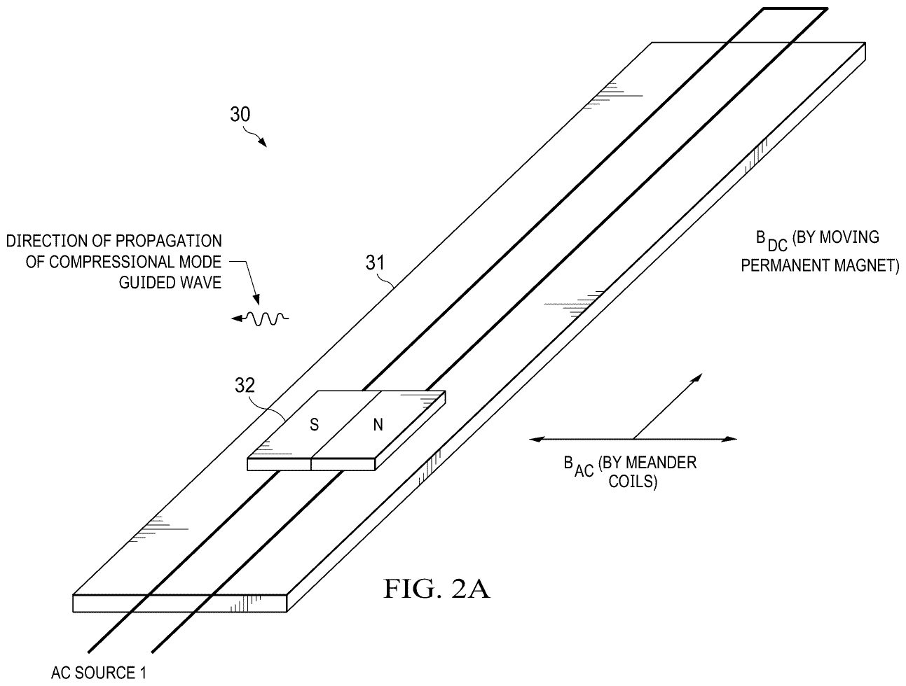

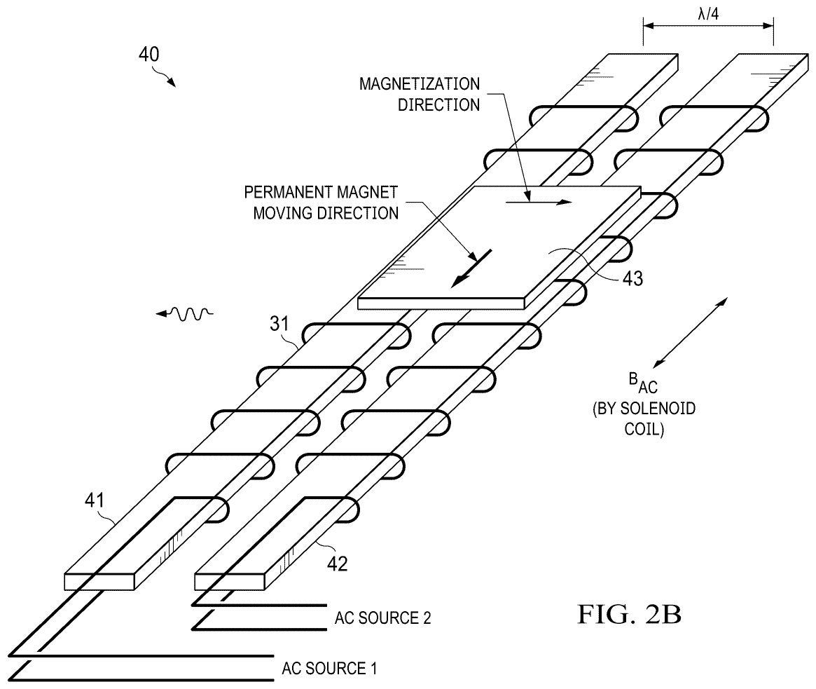

FIG. 2 illustrates a magnetostrictive sensor 30 in accordance with the invention, referred to herein as a “partial activation” magnetostrictive sensor. Sensor 30 is located on the surface of a structure 34 to be tested. Only a portion of structure 34 is shown; it is assumed to be part of a larger structure undergoing magnetostrictive testing for structural anomalies.

Structure 34 may be the outer surface of a pipeline or other tubular structure. Sensor 30 may be configured to be placed around the circumference. Or sensor 30 may be placed along the axial direction to generate and receive circumferential guided waves. For both applications, sensor 30 may be configured to excite shear horizontal or compressional guided waves.

FIG. 2A illustrates magnetostrictive sensor 30 configured for compressional guided wave generation. “BDC” refers to the static magnetic field, and “BAC” refers to the pulsed magnetic field. For compressional wave generation, the coil of strip 31 is in the direction of the length of strip 31 as in FIG. 2A.

As compared to pipelines or other tubular structures, structure 34 may be a flat plate-type structure. For these applications, sensor 30 may be configured to generate compressional guided waves.

From the above, it should be clear that the configuration of coil 31 and magnet 32 may depend on the structure being tested and the type of guided wave desired to be generated. Various configurations of coils and magnets for magnetostrictive sensors are described in U.S. Pat. No. 11,346,809 and incorporated herein by reference. In general, a magnetostrictive strip 31 is configured to produce a time-varying magnetic field that is perpendicular to a static magnetic field produced by permanent magnet(s) 32.

Magnetostrictive strip 31 is a flat thin piece of ferromagnetic material, typically having a long rectangular shape. In general, strip 31 has planer dimensions (length and width) and a thickness much less than its planar dimensions.

Strip 12 is wound with one or more radio frequency coils. It produces a time-varying magnetic field when activated with an AC current provided by generator 35.

A magnetostrictive strip 31 of a predefined length and path can be customized for geometries of the testing structures. Strip 31 may be made from a flexible material. This results in a flexible sensor 30 that can have an arbitrary path that matches the surface profile of the structure under test. In the example of FIG. 2, the surface profile is flat, but this need not be the case.

Magnetostrictive strip 31 is acoustically coupled to the test structure 34. This may be accomplished by using an appropriate couplant. The coupling may be achieved mechanically or adhesively using various acoustic coupling techniques.

Rather than a fixed permanent magnet or a fixed array of permanent magnets covering the length of strip 31 as in FIG. 1, a single permanent magnet 32 (or a small array of permanent magnets) covers only a small extent of the magnetostrictive strip 31. In the embodiment of FIG. 2, magnet 32 covers all or most of the width of strip 31 but only a small portion of its length.

Magnet 32 is moveably placed atop strip 31. As indicated in FIG. 2, magnet 32 is oriented to generate shear horizontal guided waves in the direction shown.

As explained below, in operation, magnet 32 is moved along strip 31. A guided wave signal is generated and a response signal is received in the coil wrapped around strip 31, but only from the part of the strip that is covered by magnet 32. The permanent magnet 32 is moved under automatic control or manual control to excite guided waves at predefined positions.

In an automated control embodiment, a motor 33 drives magnet 32 to different positions along strip 31, thereby achieving a linear scan. An experimental embodiment can perform an automated scan up to 660 mm long, with axial resolution as high as 1 mm.

In this manner, manual manipulation of the probe is minimized and test speed and resolution are increased. In addition, scan data from various aperture sizes can be obtained with minimal efforts by using magnets of different lengths scanned over the same magnetostrictive strip. A signal processor 36 receives and analyzes response data.

In operation, both the commonly-designated ultrasonic pitch-catch and pulse-echo data acquisitions can be achieved with sensor 30 with appropriate transmitter/receiver configurations. The pitch-catch configuration requires individual transmitters and receivers. With appropriate synchronization, multiple flexible sensors 30 can be deployed at the boundaries of the test area and pitch-catch data with high spatial resolution can be obtained for tomography. A pulse-echo configuration uses the same sensor for both the guided wave transmission and reception.

FIG. 2B illustrates how a magnetostrictive sensor 40 can be configured for directional guided wave selection. Two coil-wrapped magnetostrictive strips 41 are separated by a quarter wavelength (λ/4) of the preferred wave mode. Controlled phasing is used for the excitations and reception in the coils. Both strips 41 have their coils wrapped around the width (shorter dimension) of strips 41 and the same orientation relative to strips 41.

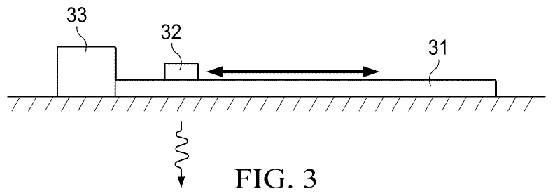

FIG. 3 is a side view of sensor 30 and motor 33 for moving the magnet 32 along the surface of strip 31. The same concept applies for moving the magnet 43 of sensor 40 or of other “partial activation” magnetostrictive sensor configurations.

Movement of magnet 32 is in the direction shown by the arrow. Magnetostrictive strip 31 is acoustically coupled to a surface 34. The guided waves propagate in the structure in the direction shown, are reflected back to sensor 30, and the response signals are delivered to signal processor 36 for detection of anomalies in the pipe wall. If sensor 30 is installed axially along the outer surface of a pipeline, the guided waves may travel around the entire circumference of a pipe.

Although not explicitly shown in FIG. 3, sensor 30 may have a track, rail, or other means for guiding magnet 32 along the length of strip 31. A C-slot is another possible means for guiding magnet 32. Motor 33 may be a stepper motor.

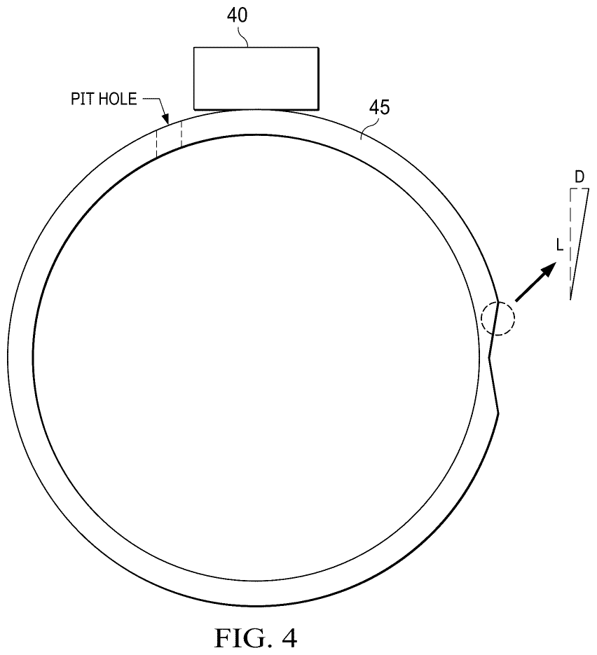

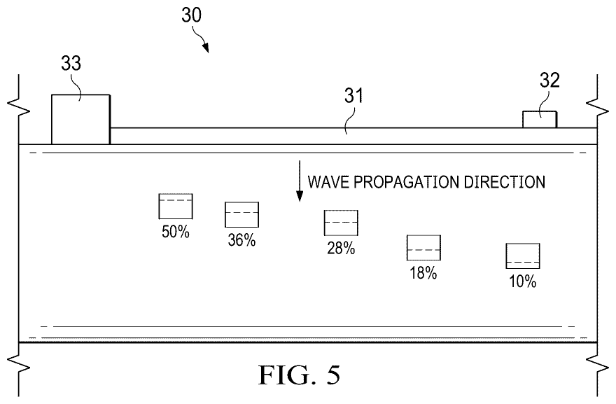

FIGS. 4 and 5 illustrate sensor 40 used in a pulse-echo configuration for testing a pipeline 41 or other pipe-like (referred to herein as “tubular”) structure. In the embodiment of FIGS. 4 and 5, sensor 40 is configured with two coils for directional control. However, the same concepts apply to sensor 30 or other “partial activation” configurations.

More specifically, FIG. 4 is a schematic of a cross section of the pipe showing sensor 40, a pit hole, and gradual wall thinning patches. FIG. 5 illustrates the pipe 45 with five wall thinning patches and dashed lines indicating the deepest spot of each patch.

Sensor 40 is installed along the pipe top and the guided wave propagation direction is around the circumference, as labeled with an arrow in FIG. 5.

Experiments were conducted using a steel pipe of 406 millimeter outer diameter and 10 millimeter wall thickness. As illustrated in FIG. 5, five “V” shaped, 38 mm wide gradual wall thinning patches with depths of 10%, 18%, 28%, 36%, and 50%, were introduced by machining. The smoothness of thickness change is defined using the ratio of the depth d and bottom length L of wall thinning. Along the wave propagation direction, the 50% deep patch had a ratio of approximately 1:3, the 36% deep patch had a ratio of 1:5, the 28% deep patch has a ratio of 1:6, and the other two patches had ratios of 1:10. There is a 12.5 mm diameter pit hole located at the same axial position as the 10% wall thinning patch but on the other side of the probe.

The permanent magnet 43 used to generate SH guided waves had a length of 127 millimeters and a width of 12.5 millimeters. The scan increment was 12.5 millimeters. The excitation signal was a 250 kHz, 5-cycle sinusoidal wave burst to generate combined SH0/SH1 torsional guided wave modes, respectively. The responses were recorded at a sampling frequency of 5 MHz, and five waveforms were averaged for each scan position.

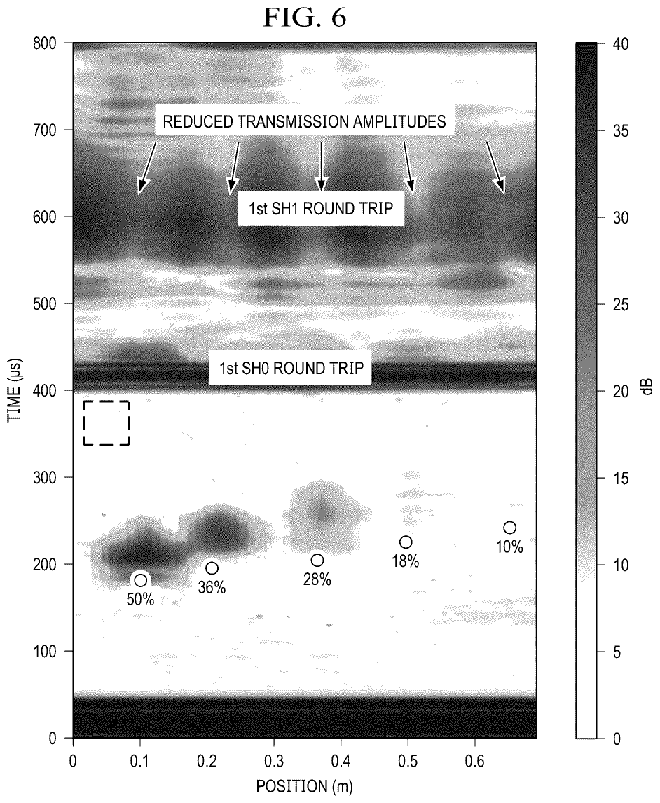

FIG. 6 illustrates a B-scan image of guided wave responses using the setup of FIGS. 4 and 5. With 250 kHz, five-cycle excitation, both SH0 and SH1 modes were generated. The five cycles were selected to separate the first round-trip signals of the SH1 mode from the second round-trip signals of the SH0 mode. Data were acquired with directional control, i.e., a sensor having two coils was excited. FIG. 6 is in log-scale using the averaged signal amplitude within the dashed box as reference. The group velocity of the SH1 mode is estimated as approximately 2.5 millimeters/microsecond using its first round-trip signal, which also matches the theoretical value of 2.48 millimeters/microsecond.

No SH0 mode wall thinning reflections were observed since the thickness changes are fairly smooth such that total transmission of the SH0 mode is supposed to occur. The 50%, 36%, and 28% wall thinning patches were easily detectible with the reflected SH1 mode wave packets. Furthermore, the wall thinning depth information can be obtained by comparing the amplitudes of the reflected wave packets from each patch, which increases with defect depth.

The wall thinning localization can also be obtained by comparing the time of arrival (ToA) of each reflected wave packet. The white circles show the calculated ToAs of the SH1 mode reflection from the defect leading edge and they match the recorded wave packets reasonably well. In addition, the dispersion-related wave-packet spreading becomes more severe toward the shallower wall thinning patches, which not only indicates again that all the wave packets in reflection are the SH1 mode but also provides distance information.

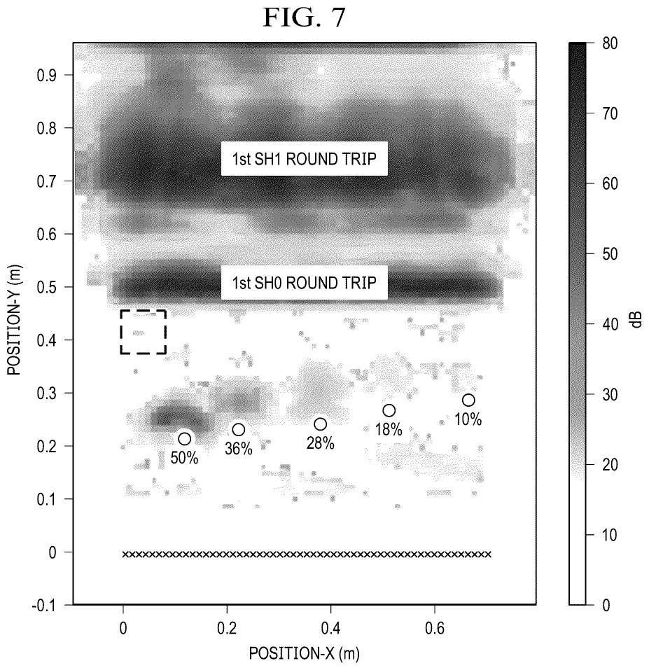

FIG. 7 illustrates a SAFT image of guided wave responses using the 250 kHz five-cycle excitation. SAFT imaging may be used to better concentrate energy. As in FIG. 6, directional control was used in data acquisition and log-scale was used in imaging. As shown, the SAFT image significantly improves the signal-to-noise ratio from a 40 dB range in the B-scan image to a 80 dB range while still being able to reduce artifacts in the vicinity of defect indications. A slightly enhanced detection of the 18% wall thinning is also obtained. Further improvement of imaging performance can be achieved using a smaller aperture (magnet) such that the beam spread is wider.

1. A pulse-echo method of magnetostrictive guided wave testing of a structure, comprising:
acoustically coupling a magnetostrictive strip to a surface of the structure, the magnetostrictive strip having a coil-wrapped strip of ferromagnetic material, the strip having a width thinner than its length;
placing a permanent magnet over a portion of the strip, such that the permanent magnet covers all or most of the width of the strip but only a portion of its length;
using a pulsed alternating current source to activate the magnetostrictive strip, thereby producing time-varying magnetic fields and magnetostrictive vibrations in the magnetostrictive strip, and thereby resulting in guided waves in the structure;
receiving response signals from the strip;
moving the permanent magnet to a next position along the length of the magnetostrictive strip;
receiving additional response signals from the strip;
repeating the steps of moving and receiving additional response signals until a desired portion of the structure under the strip is tested; and
analyzing the response signals to detect any anomalies in the structure.

2. The method of claim 1, wherein the magnetostrictive strip and permanent magnet are configured to generate shear horizontal guided waves.

3. The method of claim 1, wherein the magnetostrictive strip and permanent magnet are configured to generate compressional guided waves.

4. The method of claim 1, wherein the moving step is performed with a motor.

5. The method of claim 1, wherein the magnetostrictive strip is made from a flexible material, and wherein the acoustically coupling step is performed by conforming the strip to the surface.

6. A pitch-catch method of magnetostrictive guided wave testing of a structure, comprising:
acoustically coupling two magnetostrictive sensors to a surface of the structure, the magnetostrictive sensors having a coil-wrapped strip of ferromagnetic material, the strips having a width thinner than its length, and having a permanent magnet on the strip;
wherein the strips are separated for pitch-catch operation;
wherein the permanent magnet of a first of sensors covers all or most of the width of the strip but only a portion of its length;
using a pulsed alternating current source to activate the first of the sensors, thereby producing time-varying magnetic fields and magnetostrictive vibrations in that sensor, and thereby resulting in guided waves in the structure;
receiving response signals from a second of the sensors;
moving the permanent magnet to a next position along the length of the first of the sensors;
receiving additional response signals from the second of the sensors;
repeating the steps of moving and receiving additional response signals until a desired portion of the structure under the first of the sensors is tested; and
analyzing the response signals to detect any anomalies in the structure.

7. The method of claim 6, wherein the sensors are configured to generate shear horizontal guided waves.

8. The method of claim 6, wherein the sensors are configured to generate compressional guided waves.

9. The method of claim 6, wherein the moving step is performed with a motor.

10. The method of claim 6, wherein the magnetostrictive strip is made from a flexible material, and wherein the acoustically coupling step is performed by conforming the strip to the surface.

11. A method of magnetostrictive guided wave testing of a structure, comprising:
acoustically coupling a pair of magnetostrictive strips to a surface of the structure, each magnetostrictive strip having a coil-wrapped strip of ferromagnetic material, the pair of magnetostrictive strips being separated by one-quarter wavelength of a preferred wave mode;
wherein the strips have a width thinner than their length;
placing a permanent magnet over a portion of the strips, such that the permanent magnet covers all or most of the width of the strips but only a portion of their length;
using a pulsed alternating current source to activate the magnetostrictive strips, thereby producing time-varying magnetic fields and magnetostrictive vibrations in the magnetostrictive strips, and thereby resulting in guided waves in the structure;
receiving response signals from the strips;
moving the permanent magnet to a next position along the length of the magnetostrictive strips;
receiving additional response signals from the strips;
repeating the steps of moving and receiving additional response signals until a desired portion of the structure under the strips is tested; and
analyzing the response signals to detect any anomalies in the structure.

12. The method of claim 11, wherein the moving step is performed with a motor.

13. The method of claim 11, wherein the magnetostrictive strips are made from a flexible material, and wherein the acoustically coupling step is performed by conforming the strips to the surface.

14. A magnetostrictive guided wave test system for nondestructive testing of a structure for defects, comprising:
a magnetostrictive strip having a coil-wrapped strip of ferromagnetic material, the strip having a length and a width;
a permanent magnet sized to cover all or most of the width of the magnetostrictive strip but only a portion of its length;
a motor operable to move the permanent magnet along the length of the strip; and
a signal generator operable to apply a pulsed alternating current source to activate the magnetostrictive strip, thereby producing time-varying magnetic fields and magnetostrictive vibrations in the magnetostrictive strip, thereby resulting in guided waves in the structure.

15. The test system of claim 14, wherein the magnetostrictive strip and the permanent magnet are configured to generate shear horizontal waves when the strip is activated by a pulsed alternating current source.

16. The test system of claim 14, wherein the magnetostrictive strip and the permanent magnet are configured to generate compressional waves when the strip is activated by a pulsed alternating current source.

17. The test system of claim 14, wherein the magnetostrictive strip is made from a flexible material.
